(19) United States
(12) Patent Application Publication
(10) Pub. No.: US 2004/0085944 A1
(43) Pub. Date: May 6, 2004

(54) Portable wireless internet gateway

(76) Inventor: Lawrence D. Boehm, Alpharetta, GA (US)

Correspondence Address: GREGORY SCOTT SMITH, P.O. Box 88148, ATLANTA, GA, 30350, US

(21) Appl. No.: 10/287,316

(22) Filed: Nov. 4, 2002

(51) Int. Cl. H04Q 7/24

(52) U.S. Cl. 370/338; 370/312

(57) ABSTRACT

A method for a network device is described, illustrated and claimed. The novel device couples a hub/switch, a router and a interchangeable network interface to access an external network. The hub/switch serves as a central point of connection to a first and second plurality of PCs and other devices forming a LAN. The router serves as a barrier to protect the LAN from the external network. The wireless interface is an interface that accepts short range wireless networking protocols. The interchangeable network interface accepts telecommunication modules enabling shared wireless network access that interface with the external network and the Internet.

### TECHNICAL FIELD

The present invention relates to computer networking and, more particularly to a device that provides a local area network and enables devices residing on the network to access a global data network using an interchangeable connection; enabling shared wireless Internet access.

### BACKGROUND OF THE INVENTION

Increasingly, more people are using the Internet. In business, even in small businesses, virtually every single employee needs Internet access to effectively complete his or her daily tasks. Additionally, in the home, families are using the Internet to surf for information, send electronic messages, chat, shop, homework, research and even call a friend.

Typically, a modem is used to connect a personal computer (“PC”) to the Internet. Traditionally, a common modem is installed or connected to a PC. The modem is then connected to a single phone line that connects to an Internet Service Provider (“ISP”), which provides Internet access. This method of connecting multiple computers individually to the Internet quickly becomes cost-prohibitive and management-intensive. Access is limited and this approach demands a new phone line and Internet account for each user. Today, a better solution for business and in homes using more than one computer is to create a networked Internet connection.

A networked Internet connection comprises a shared network connected to the Internet through a modem or other networking equipment. A network is a group of computers, printers, and other devices that are connected together either through cables (usually Ethernet cables) or a wireless 802.11 system. Information travels over the cables or through the air, allowing the network users to exchange documents and data with each other, print to the same printers, and generally share any hardware or software that is connected to the network. Each computer, printer, or other peripheral device that is connected to the network is called a node. Networks can have tens, thousands, or even millions of nodes. Therefore, combining a modem or other similar ISP connection with a network allows all users on the network access to the Internet connection.

Typically, a networked Internet connection comprises an ISP interface (e.g. modem), a router, a hub or a switch, network interface cards (“NICs”) and an Ethernet cable for a wired network or a wireless access point for a wireless network. The interface, such as dial-up, DSL, Cable, Ethernet, 802.11 wireless LAN (“WAN”) or high bandwidth facilities like T1, T3, DS3, or other similar technologies connects the network to an external ISP network allowing access to the Internet. The router provides routing, filtering, network address translation, firewall, DHCP, automatic network login services and other services. The hub connects PCs in the network implementing a networked topology—just like the telephone system—in which all connections can contact each other through the network. The switch can replace or augment hubs in networks where high volumes are common. The switch manages the network traffic more intelligently so that multiple separate conversations can occur simultaneously (rather like a telephone system). The NICs, also known as adapters, are located in each PC on the network. The NIC connects each PC to the network through the Ethernet cables or the wireless access point. The Ethernet cable physically connects all of the PCs together with a hub or switch in a wired network. The wireless access point connects additional, generally portable, PCs together over the air with a hub or switch in a wireless network. In either network type, wired or wireless, some physical connection is required, usually between the router and the interface or between the interface and the external network. The same is true in an enterprise network, where multiple of these devices are used in conjunction to form a Wide Area Network allowing many devices to interact, connect to an internal network and connect to the Internet.

This configuration limits the network to a particular physical area, thus, limiting the networks portability. In addition, technology changes rapidly requiring the interface to be updated or replaced often to keep up with demands in network speeds, technology changes, or revisions.

Recently, wireless service providers have enabled wireless network access to the internet utilizing their wireless infrastructure. Thus, making them wireless ISPs enabling customers with the proper equipment to access their network and Internet.

What is needed, therefore, is a completely wireless network apparatus that is both portable and adaptable to changes in technology, networks, and revisions.

### SUMMARY OF THE INVENTION

In general, the present invention can be described as a novel apparatus for providing a portable and adaptable Internet gateway enabling wireless Internet access. More specifically, the present invention is the combination of a hub/switch, router, wireless interface and interchangeable network interface, coupled together to provide a LAN and access to an external network. The hub/switch serves as a central point of connection to a first and second plurality of PCs and other devices forming a LAN. The router serves as a barrier to protect the LAN from the external network. The wireless interface allows local area connectivity via short range wireless technologies. The interchangeable network interface accepts telecommunication modules that interface with the external network and the Internet enabling a wireless connection.

The portable wireless Internet gateway combines different technologies into one useful system. One aspect of the invention is the use of a telecommunications module to connect to any type of network, including: CDMA, IDEN, GSM, or similar wireless provided networks. It allows users to share their wireless provided network connection and be on the same network. It should be understood that the telecommunications module could take on a variety of forms but for illustrative purposes, the invention will be described as being embodied within a PCMCIA card and interfacing to the CDMA network.

The portable wireless Internet gateway has several advantages, a few of them being: small and compact size, portable network able to connect to the Internet, wireless technology avoids having to use cables, instant access to both the external and internal networks to which it is interfaced, interchangeable interface to quickly adapt to new technologies, revisions and various types of networks and connections.

### BRIEF DESCRIPTION OF THE DRAWINGS

Other aspects, advantages and novel features of the invention will become more apparent from the following detailed description of exemplary embodiments of the invention when considered in conjunction with the accompanying drawings wherein:

FIG. 1 is an illustration that depicts a traditional home or small business connection to the Internet.

FIG. 2 is an illustration that depicts typical networking components connected together to form a local area network connected to the Internet.

FIG. 3 is an illustration of an exemplary embodiment of the present invention depicting a local area network connected to the Internet.

### DETAILED DESCRIPTION

In general, the present invention can be described as a novel apparatus that provides a portable and adaptable Internet gateway enabling shared wireless Internet access. More particularly, the present invention uses wireless data communication technology to provide a shared and networked interface to a global data network, such as the Internet through a macro wireless data network. Advantageously, the present invention enables great flexibility in the reconfiguration and initial set up of a network because the concerns affiliated with moving a wired network access points are removed.

Referring now to the figures, in which like numerals refer to like elements throughout the several views, exemplary embodiments of the present invention are described. Throughout the detailed description, reference will be made to the operation of the present invention in conjunction with a network including computing devices. Within this context, computing devices may include, but are not limited to, personal computers (“PCs”), mainframe computers, servers, handheld devices and any other electronic device capable of being networked or associated with the present invention such as, but not limited to remote monitoring sensors and equipment. It should be understood that the features and aspects of the present invention can be adapted for a variety of electronic devices, systems and system/network configurations and any examples provided within this description are for illustrative purposes only.

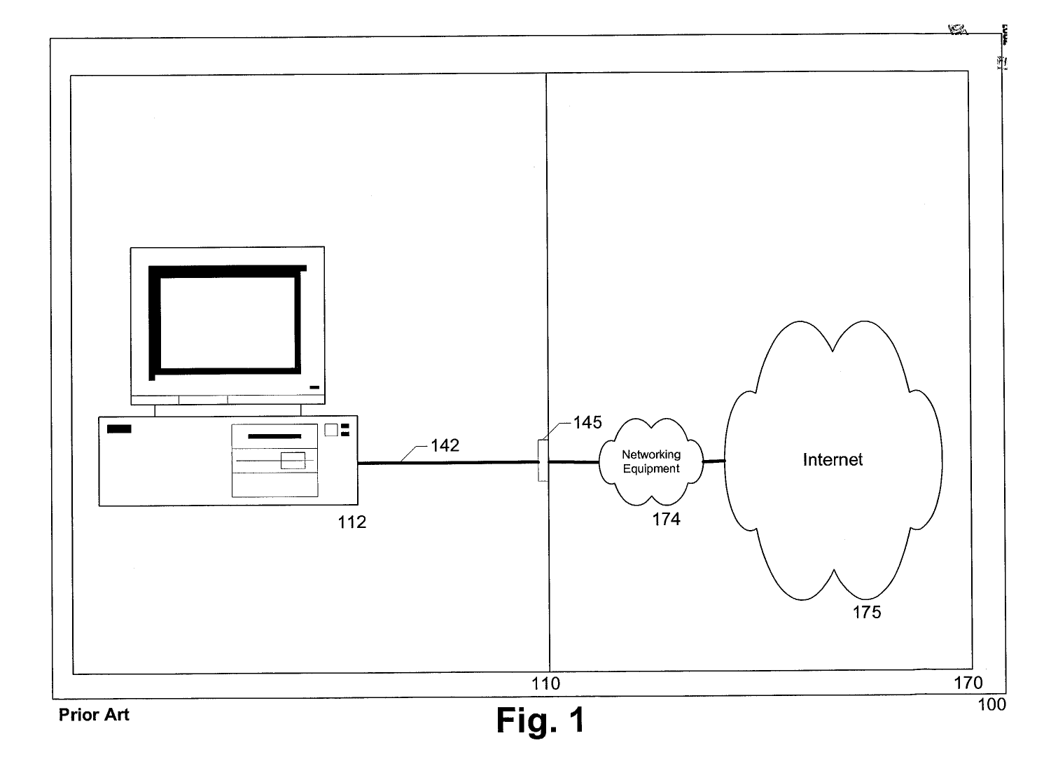

FIG. 1 illustrates a traditional connection to the Internet utilized for a small business or home. A network landscape 100 includes an internal network 110 and an external network 170. The typical internal network consists of a single PC 112 containing a modem card, dial-up, cable, DSL or such connected to a wall jack 145 through a typical telephone cable 142. In this example, the wall jack 145 is a typical telephone jack; however, a person skilled in the art will recognize other, personal or small business connections to the Internet can be accomplished using the variety of DSL lines, cable modems, T1 lines or the like through common or specialized equipment. The single PC 112 interfaces to the Internet 175 through the telephone cable 142 connected to an ISP and their networking equipment 174, such as, but not limited to the public switching telephone network (PSTN). The networking equipment 174 then connects to the Internet 175. This configuration is used often when only a single connection to the Internet is needed.

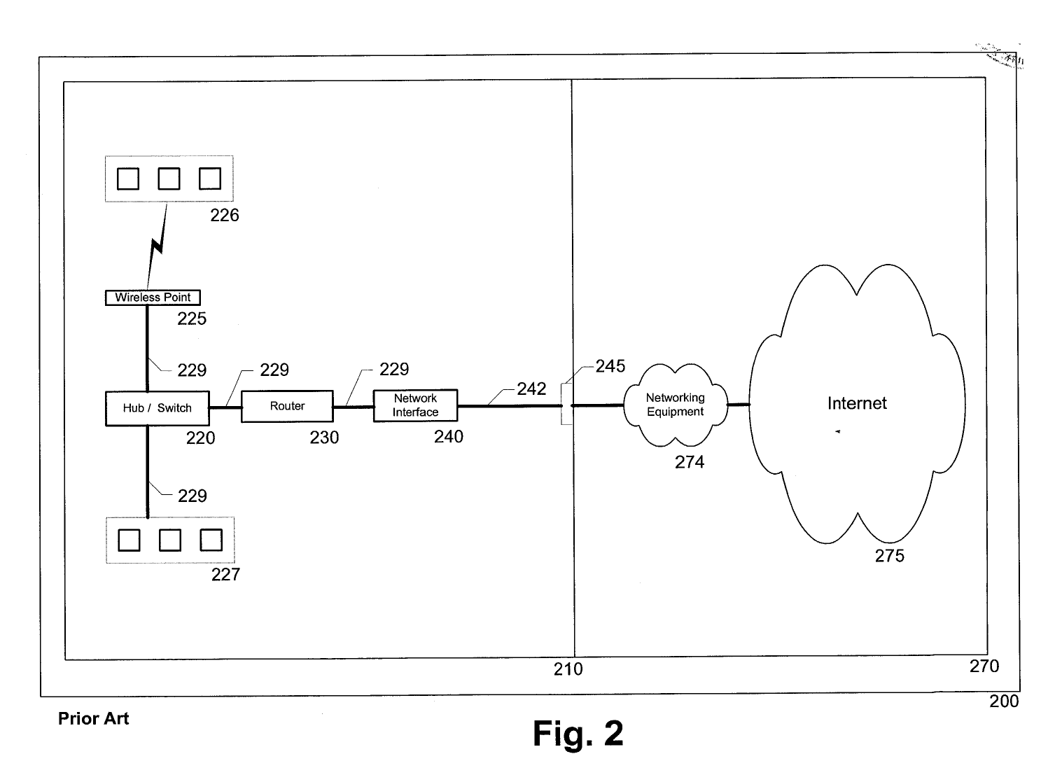

FIG. 2 illustrates typical networking components connected together to form a local area network (“LAN”) connected to the Internet. A network landscape 200 includes an internal network 210 and an external network 270. The internal network 210 can include a variety of components, sub-networks, or the like, including, but not limited to: one or more groups of PCs and other devices 226, 227; one or more hubs/switches 220; one or more wireless access points 225; one or more routers 230; a network interface (modem, T1 interface, etc) 240; cable 229; telephone, modem, Ethernet or other type of cable 242 and a wall jack 245. The internal network 210 may include one combination unit that serves the purpose of the hub/switch 220; wireless access point 225; router 230; network interface (modem, T1 interface, etc) 240; and cable 229, however, for illustration purposes, the components are depicted individually. The hub/switch 220 serves as a central point of connection to the PCs and other devices 226, 227 forming the LAN. The hub/switch 220 may be connected to a wireless access point 225 through a cable 229 which allows wireless communication to the first group of PCs and other devices 226. The hub/switch 220 can be connected to a second plurality of PCs and other devices 227 through a cable 229. The groups of PCs and other device 226, 227 contain a NIC or similar device used to communicate with the wireless point 225 or hub/switch 220. The hub/switch 220 may also be connected to the router 230 through a cable 229. The router 230 directs traffic within the LAN to the various destinations or to the Internet and can serve as a barrier to protect the LAN from the external network 270. It should be noted that many different configurations exist to provide firewall services to a LAN or WAN and this is used only as an example. The router 230 may communicate with the network interface (modem, T1, etc) 240 through a cable 229. Further, the router 230 may interface with multiple local or external networks. The network interface (modem, T1, etc) 240 may be connected to the wall jack 245 through a cable 242 for communication with the external network 270. The wall jack 245 connects the internal network 210 to the external network 270. The wall jack 245 may be a phone jack, cable jack, equipment rack, T1, enterprise network, or similar type of connection providing access to networking equipment 274, such as, but not limited to an ISP or the public switching telephone network (PSTN), connecting to the Internet 275.

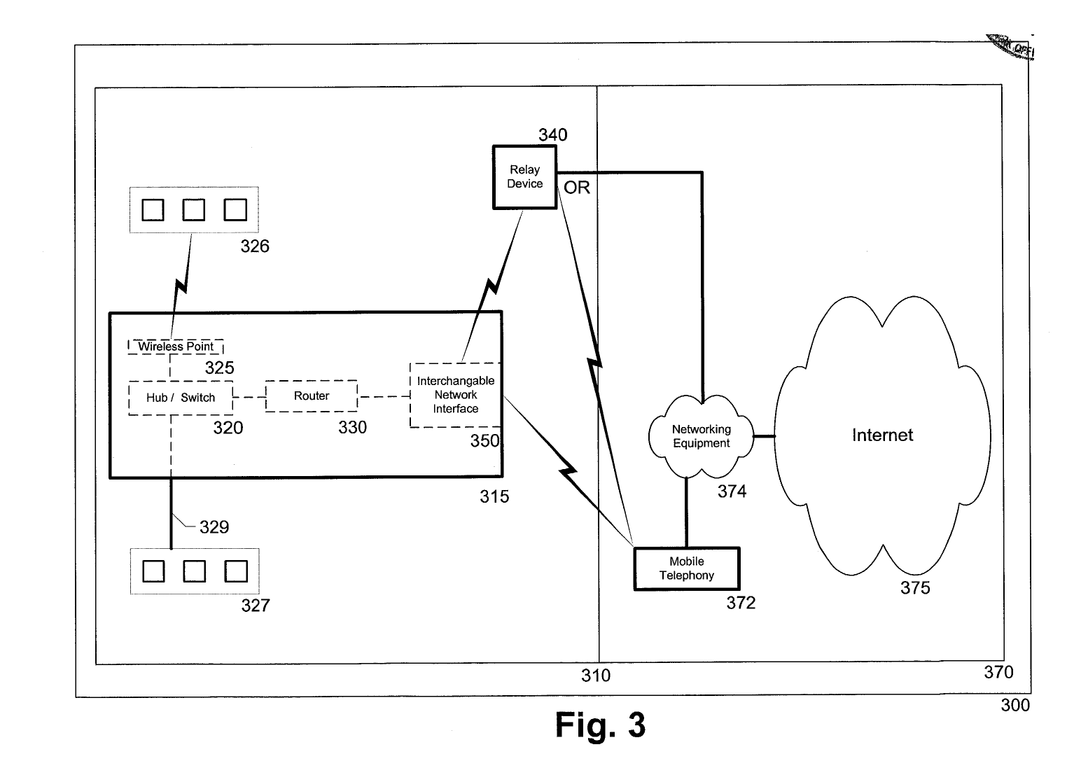

FIG. 3 illustrates an exemplary embodiment of the present invention depicting a LAN connected to the Internet. In FIG. 3 a network landscape 300 is illustrated depicting an internal network 310 and an external network 370. The internal network 310 consists of a portable wireless Internet gateway 315 connected to one or more groups of PCs and other devices 326, 327 forming a LAN. The portable wireless Internet gateway 315 is also connected to the external network 370. In an exemplary embodiment, the portable wireless Internet gateway 315 includes, but is not limited to: a local networked interface, an interchangeable network interface 350 and a router 330. The local networked interface includes, but is not limited to: a hub/switch 320 and a wireless access point 325. It should be understood that the hub/switch 320 can take on a variety of forms but for illustrative purposes, the hub/switch 320 will be described as being a mini Ethernet hub.

The mini Ethernet hub 320 serves as a central point of connection to the first and second plurality of PCs and other devices 326, 327 forming the LAN. The mini Ethernet hub 320 can be coupled to a wireless access point 325 for a wireless interface to a first group of PCs and other devices 326. In one exemplary embodiment, the wireless point 325 utilizes 802.11 b wireless communication technology. The mini Ethernet hub 320 can be connected to a second group of PCs and other devices 327 through a cable 329. The first and second groups of PCs and other device 326, 327 contain a NIC or other similar device to interface with the wireless access point 325 or mini Ethernet hub 320. The mini Ethernet hub 320 can be coupled to the router 330.

The router 330 serves as a barrier to protect the LAN from the external network 370. The router 330 provides routing, filtering, network address translation, firewall, DHCP, and automatic network login services for the LAN. The DHCP service can accept a DHCP IP address from the remote connected network and/or provide local DHCP services to the computers connected to the router 330. The router 330 will create the LAN using a definable subnet range or private IP address. The router 330 can also provide a secure bridge between the connected networks. The router 330 is coupled to the interchangeable network interface 350. The router 330 uses typical address translation and assignment by using subnets within the internal network to address the LAN.

Wireless access to the external network 370 is provided through the interchangeable network interface 350. The interchangeable network interface 350 can be provided in a variety of manners. In one embodiment, the interchangeable network interface 350 is provided through the use of a removable module that can be inserted into the portable wireless Internet gateway 315. The interchangeable network interface module includes an interface to the external network 370 and/or the Internet 375 through a wireless connection. It should be understood that this module can take on a variety of forms but for illustrative purposes, the invention will be described as being embodied within a PCMCIA slot and compatible card and supporting a data interface to the CDMA network. Thus, in an exemplary embodiment, the portable wireless Internet gateway 315 includes a PCMCIA slot to accept a PCMCIA card, such as the AirCard® 555 CDMA 1xRTT Wireless Network Card marketed by Sierra Wireless.

Depending on the wireless technology utilized to access the Internet, the portable wireless Internet gateway 315 will interface to some form of a network, server or switch. For instance, in the AirCard® 555 example, the AirCard® will interface through a mobile telephony channel 372 such as a cellular CDMA communication channel, to networking equipment 374 such as a mobile telephone switching office (MTSO) or ISP. The networking equipment 374 then interfaces to the Internet 375 through a portal, ISP, PSTN or another technique that those skilled in the art will understand.

The use of an interchangeable network interface module allows the portable wireless Internet gateway 315 to be easily moved from one location to the next. In addition, the use of a removable module allows the portable wireless Internet gateway 315 to connect to the Internet through a variety of wireless technologies depending upon the technology supported by the interchangeable network interface module (i.e., CDMA 1x or 3G, IDEN, GSM, GPRS, TDMA, 4G, 5G, CDPD, etc). In fact, the present invention should not be limited to any particular wireless protocol or technology, but rather, for deployment of the present invention, a wireless connection to a global data network, such as the Internet, can be accomplished using any wireless technology with sufficient range. It should be understood by those skilled in the art that the interchangeable network interface module could utilize a variety of technologies, other than the PCMCIA technology, for interfacing to the portable wireless Internet gateway. Some of these technologies may include, but are not limited to: USB interface, flash memory interface or proprietary or other interfaces.

In another embodiment of the present invention, the interchangeable network interface 350 utilizes a wired communication device, allowing a connection through a wired network. It should also be understood that the present invention, should not be limited to any particular wired communication device, but rather, a wired connection to a global data network, such as the Internet, can be accomplished using any wired technology or other, to connect to any external network such as dial-up, DSL, cable, Ethernet 802.11 b Wireless WAN, or Wireless network. As networks evolve, the interchangeable interface 350 would utilize a new PCMCIA card or similar interface for connection to an external network.

In another embodiment, the wireless technology in the interchangeable network interface 350 may be a short-range transmission technology, such as IEEE 802.11, rather than a mobile technology. In this embodiment, the portable wireless Internet gateway 315 may interface to another wireless device, a relay device 340 that includes the ability to transmit and receive data with the portable wireless internet gateway 315 and provides either wired access to the Internet 375 through networking equipment 374 or wireless access to the Internet 375 through a mobile telephony channel 372. In this embodiment, the advantages of a portable wireless Internet gateway are still realized. The gateway is still mobile as long as it remains within the range of the relay device 340. The relay device 340 can also be entirely mobile if it uses a wireless interface to access the Internet or it may be partially mobile if it requires the ability to connect to a physical jack for a wired interface to the Internet.

In another exemplary embodiment, the portable wireless Internet gateway 315 can include a wired interface, as well as the wireless interface 350, to the external network 370. This wired interface is in addition to the wireless interface 350 and can be accomplished by adding an internal modem and interfacing the external network 370 and the Internet 375 through a phone jack, cable jack, or similar type of connection.

Those skilled in the art will appreciate that the application of the present invention can take many forms and function and the examples provided herein are only used to illustrate a few of these possibilities. The scope of the present invention is not limited by these examples.

Although this disclosure describes our invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A wireless gateway device for providing shared access to a global data network, the wireless gateway device comprising:
a local network interface for interfacing to a plurality of computing devices;
an interchangeable network interface for interfacing to the global data network; and
a router for receiving data from the plurality of computing devices and routing the data towards the appropriate destination on the global data network and receiving data from the global data network directed to at least one of the plurality of computing devices and routing the data to the at least one of the plurality of computing devices.

2. The wireless gateway device of claim 1, wherein said router further comprises a hub to communicate with the plurality of computing devices through the local network interface.

3. The wireless gateway device of claim 2, wherein said local network interface is wireless.

4. A wireless gateway device for providing shared access to a wide-area data network, said wireless gateway device comprising:
a local network interface for interfacing to a plurality of computing devices;
an interchangeable network interface for receiving a wireless module that is capable of providing a wireless connection to the global data network; and
a router for:
receiving data from the plurality of computing devices and providing the data to the wireless module interface, the data being directed towards the appropriate destination on the wide-area data network, and
receiving data from the wireless module interface, the data being received from a wide-area data network directed to at least one of the plurality of computing devices and routing the data to the at least one of the plurality of computing devices.

5. The wireless gateway device of claim 4, wherein said router further comprises a hub to communicate with the plurality of computing devices through the local network interface.

6. The wireless gateway device of claim 4, wherein said router further comprises a switch to communicate with the plurality of computing devices through the local network interface.

7. The wireless gateway device of claim 4, wherein said local network interface is wireless.

8. The wireless gateway device of claim 4, wherein said interchangeable network interface can receive a PCMCIA compatible wireless module.

9. The wireless gateway device of claim 4, wherein said interchangeable network interface can receive a PCMCIA compatible wireless module that includes a mobile wireless protocol for interfacing to the wide-area data network.

10. A wireless gateway device for providing shared access to a wide-area data network, said wireless gateway device comprising:
a mini Ethernet hub, wherein said Ethernet hub utilizes at least one wired connection to create a LAN;
an IP router coupled to said Ethernet hub, wherein said IP router provides at least a subset of routing, filtering, network address translation, firewall, DHCP and network login services; and
an interchangeable network interface port coupled to said IP router, wherein said interface port is capable of receiving a telecommunication module.

11. The wireless gateway device of claim 10, further comprising a wireless point coupled to said hub, wherein said wireless point provides 802.11 b wireless communication.

12. The wireless gateway device of claim 10, further comprising a modem coupled to said IP router, wherein said modem provides a wired connection to an external network.

13. The wireless gateway device of claim 10, wherein said wireless point communicates with at least one NIC in a personal computer.

14. The wireless gateway device of claim 10, wherein said interface port is operable to interface with a PCMCIA based telecommunication module.

15. The wireless gateway device of claim 10, wherein said interface port is operable to interface with a USB based telecommunication module.

16. The wireless gateway device of claim 10, wherein said interface port is operable to interface with a flash memory based telecommunication module.

17. The wireless gateway device of claim 10, wherein the interface port is capable of receiving a telecommunications module for performing short range wireless data transmissions.

18. The wireless gateway device of claim 17, further comprising a wireless relay, said wireless relay having a first wireless interface for communicating with the telecommunications module and a second wireless interface for communicating with the wide area network.

19. The wireless gateway device of claim 10, wherein said interface port is capable of receiving a telecommunications module for performing substantially long-range wireless data transmissions.
